(19) United States
(12) Patent Application Publication
(10) Pub. No.: US 2005/0212958 A1
(43) Pub. Date: Sep. 29, 2005

(54) Mini-camera with an adjustable structure

(76) Inventors: Tsui-Jung Su, Hsin-Tien City (TW); King-Long Lee, Hsin-Tien City (TW); Wen-Hong Wu, Hsin-Tien City (TW)

Correspondence Address: BIRCH STEWART KOLASCH & BIRCH, PO BOX 747, FALLS CHURCH, VA, 22040-0747, US

(21) Appl. No.: 10/809,401

(22) Filed: Mar. 26, 2004

(51) Int. Cl. H04N 5/225

(52) U.S. Cl. 348/373

(57) ABSTRACT

A mini-camera with an adjustable structure mainly includes a camera body, a support and at least one limiting element disposed at a connection between the camera body and the support. The limiting element provides the camera body with enough friction for adjusting the viewing angle of a camera lens relative to the support. A user can step-less adjust the view angle of the camera lens of the camera body, the user doesn't need disassemble the camera body or the support, and further the user cannot damage the connection between the camera body and the support for maintaining the outside beauty of the mini-camera.

### FIELD OF THE INVENTION

The present invention relates to a mini-camera with an adjustable structure, and more particularly to a mini-camera applied in a pinhole type camera having an adjustable structure for a step-less adjustment for the viewing angle of a camera lens.

### BACKGROUND OF THE INVENTION

The standard positioning mode for a pinhole type mini-camera is shown in FIG. 1. The pinhole type mini-camera mainly includes a camera body and supporting stand. The camera body is provided with two screw holes disposed on two sides thereof, and the bottom of the support is a connecting portion that is mounted on a body to be installed. Two upright members extend from two sides of the connecting portion. Each upright member is provided with a hole that corresponds to the above-mentioned screw hole. The camera body is installed on the support by utilizing a screwing element to mount into the screw hole. However, the screwing element has the following disadvantages:

(1). During installation, the screwing element tightly attaches the upright member to the camera body and the camera body cannot shake. Then the camera lens can accurately take a picture. However, the thickness and strength of the upright member itself is not enough, and therefore difficult to calculate the force sufficient to fix the body. The screwing element is often over tightened, Which can damage the electronics. If the screwing element is held too loose then the camera body can shake easily and affect the quality of the picture.

(2). External light or other factors that influence the quality of the picture are many, and therefore the angle of the camera lens must be suitably adjusted when the user installs the camera body. During each adjustment, the screwing element must first be loosened for the angle of the camera lens to be adjusted. For above reason, it is so troublesome. Particularly, during fine adjustment, if the screwing element has been loosened and adjusted, the angle of the camera lens has already altered when re-tightening. Thus, the user can loose the screwing element when the angle of the camera lens must be varied to a large value; the user directly pulls the camera body forcing it to be rotated during fine adjustment. According to the mode of fine adjustment, frictional force between the two sides of the camera body and the upright members is generated. Therefore, not only does the surface of the camera body become scratched, but it may also become loose and shake after rotating. Simultaneously, the thread of the screwing element can damage or the screwing element can crack.

### SUMMARY OF THE INVENTION

Accordingly, it is an object of the present invention to provide a mini-camera with an adjusting structure to solve the above-mentioned problems and disadvantages.

In order to achieve the foregoing objects, the present invention provides a mini-camera with an adjustable structure. It is not required to use an extra tool to loosen the screwing element and can directly adjust the view angle of a camera lens. The mini-camera with adjustable structure mainly includes a camera body, a support and at least one limiting element disposed in-between the camera body and support. The limiting element provides the camera body with enough friction for adjusting and positioning the view angle of a camera lens relative to the support. The user can step-less adjust the viewing angle of the camera, it is not necessary disassemble the camera body and support, furthermore the user cannot damage the connection between the camera body and support for maintaining the outside beauty of the mini-camera.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective exploded schematic view of a mini-camera in the prior art.

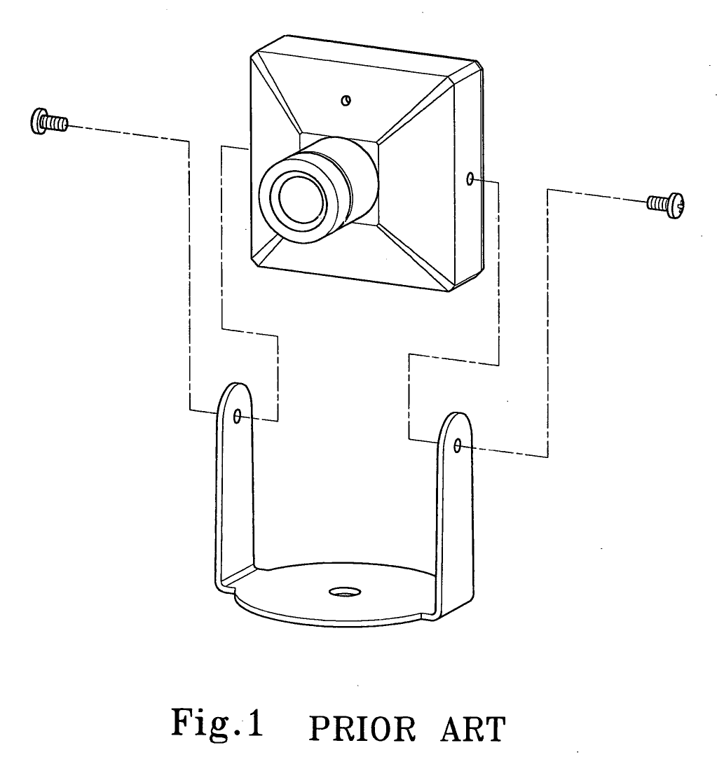

FIG. 2 is a perspective schematic view of a mini-camera of the present invention.

FIG. 3 is a perspective exploded schematic view of a mini-camera of the present invention.

FIGS. 4A and 4B are an elevated schematic view and a partially expanded sectional schematic view of a mini-camera of the present invention showing the connection between camera body and support.

FIGS. 5A and 5B are elevated side views of a mini-camera showing an adjustable viewing angle of a mini-camera of the present invention.

### DESCRIPTION OF THE PREFERRED EMBODIMENTS

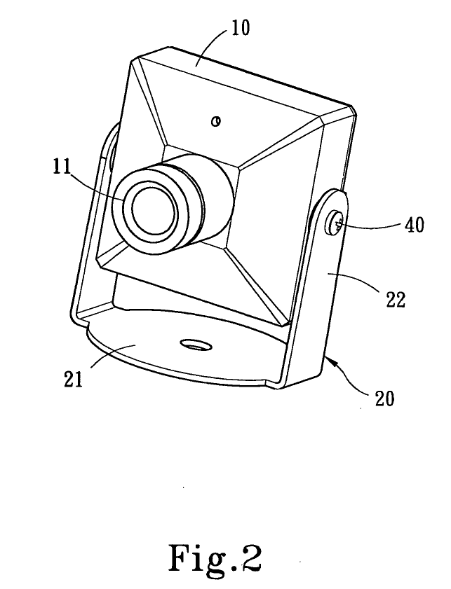

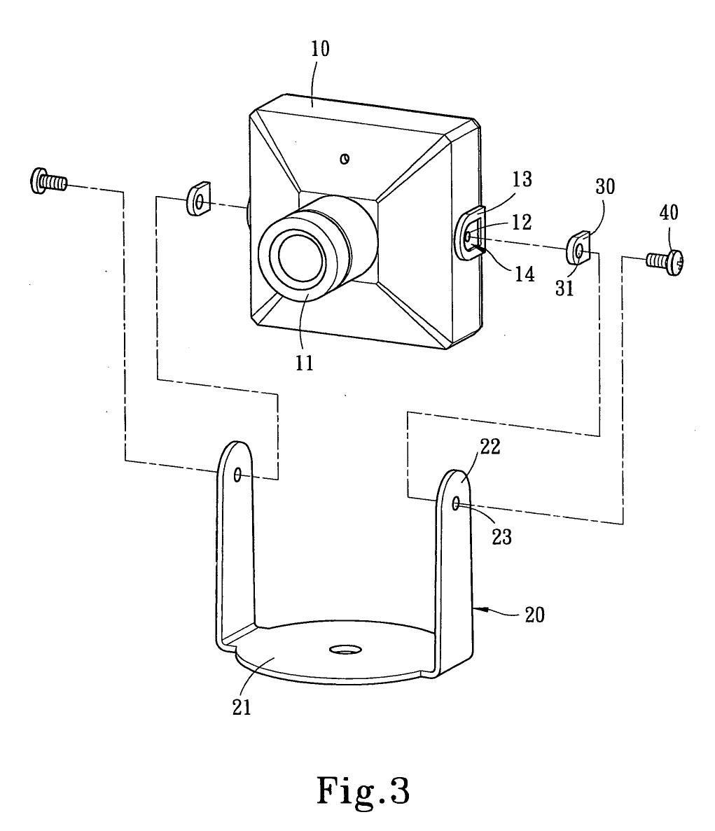

Referring to FIGS. 2 and 3, they depict a perspective schematic view and a perspective exploded schematic view of a mini-camera with an adjusting structure of the present invention. The mini-camera mainly includes a camera body 10, a support 20 and a limiting element 30 disposed at a connection between the camera body 10 and support 20. The camera body 10 is a pinhole type camera, but it is not used to limit the present invention. The camera body 10 has a camera lens 11 having two positioning holes 12 t disposed either side of the camera body 10. The positioning hole 12 can be a screw hole. A receiving area 14 is surrounded by a frame 13 disposed around the positioning hole 12 of the camera body 10 for inserting the limiting element 30. The support 20 holds the camera body 10, and further the camera body 10 can be rotated and adjusted relative to the support. The support 20 has a base 21 mounted on a body (such as a wall) for installation. Two branches 22 are upward expanded from two ends of the base 21. Each branch 22 is provided with a fixing hole 23 corresponding to the positioning hole 12, and a connecting element 40 (such as a screw) that penetrates the fixing hole 23 to the positioning hole 12 to form a connection between the positioning hole 12 and the connecting element 40. The limiting element 30 is disposed between the fixing hole 23 and the positioning hole 12 and positioned inside the receiving area 14, wherein the limiting element 30 provided with a hole 31 such that the connecting element 40 penetrates the hole 31 and the limiting element 30 provides the camera body 10 with enough friction for adjusting and positioning the view angle of the camera lens 11 relative to the support 20.

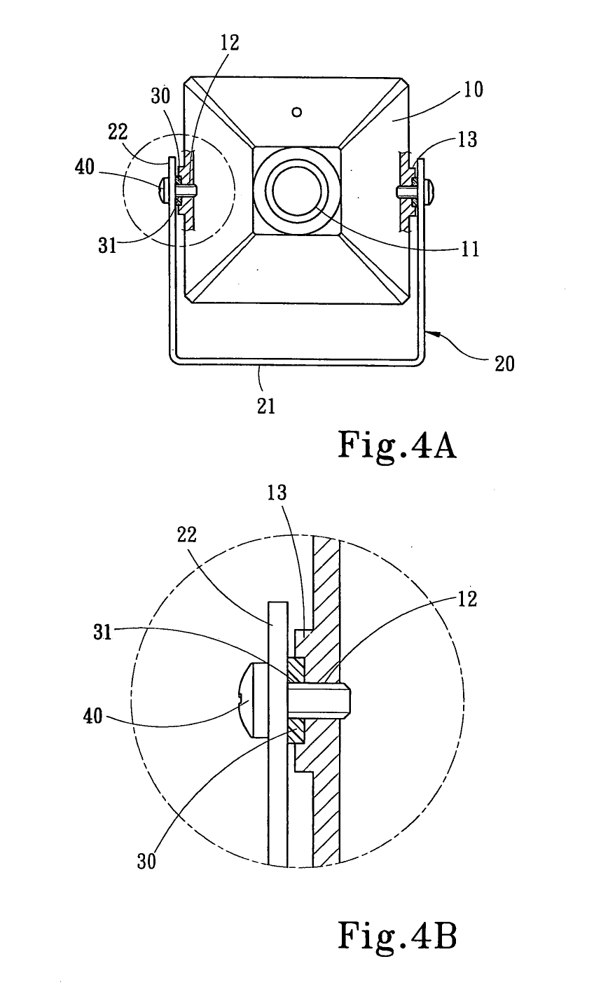

FIGS. 4A and 4B, depict an elevated schematic view and a partially expanded sectional schematic view respectively of a mini-camera with an adjustable structure of the present invention. As shown in FIGS. 4A and 4B, the length of the limiting element 30 is larger than the depth of the receiving area 14. Thus, a user utilizes the connecting element 40 to tightly force and mount the support 20 to the camera body 10 during installation. The limiting element 30 provides friction during the tightly forcing process, and therefore the user refers to the friction and can judge whether the force should be stopped. For the above reason, the connecting element 40 cannot exceed the safe scope of original tightly forcing action to prevent internal components of the camera body 10 damaging.

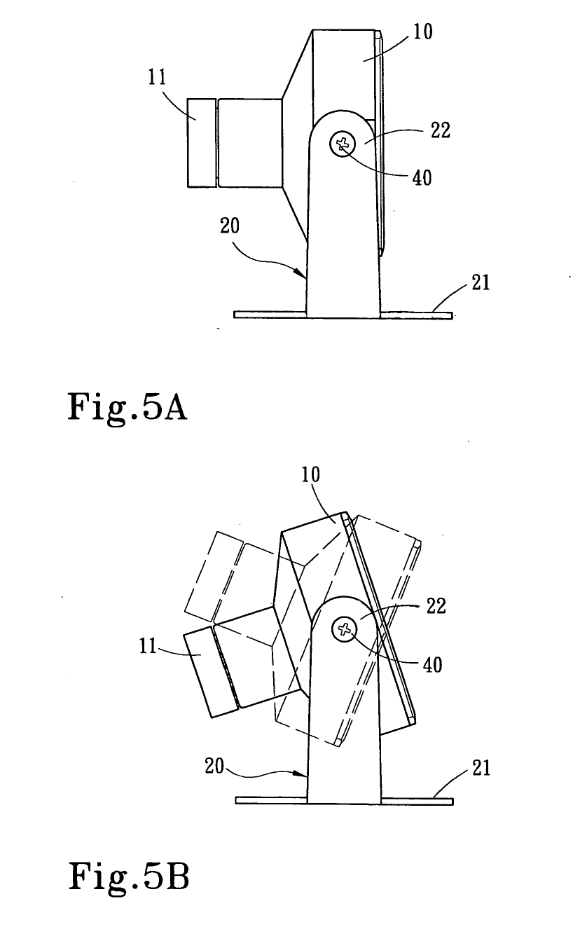

Referring to FIGS. 5A and 5B at the same time, they show a view angle of a mini-camera of the present invention which is adjusted. As shown in FIGS. 5A and 5B, when the user wants to finely adjust the viewing angle, the user only need turn the camera body 10 relative to the support 20 by utilizing the limiting element 30 that is made of some rubber material or the like. The limiting element 30 has a flexible deformable effect and the limiting element 30 is restricted by the frame portion 13, and therefore the original restricted friction can be recovered after the camera body 10 is adjusted, such that the user can step-less adjust the viewing angle of the camera and conform to the quality of taking a picture.

Although the invention has been explained in relation to its preferred embodiment, it is not used to limit the invention. It is to be understood that many other possible modifications and variations can be made by those skilled in the art without departing from the spirit and scope of the invention as hereinafter claimed.

1. A mini-camera with an adjustable structure comprising:
a camera body having a camera lens provided with a positioning hole;
a camera body support with a fixing hole that corresponds to the positioning hole;
a limiting element disposed between the fixing hole and the positioning hole, wherein the limiting element provides the camera body with enough friction for adjusting and positioning a viewing angle relative to the support.

2. The mini-camera with an adjustable structure according to claim 1, wherein the camera body has a receiving area bordered by a frame disposed around the positioning hole of the camera body, for disposing the limiting element.

3. The mini-camera with the adjustable structure of claim 2, wherein a length of the limiting element is greater than a depth of the receiving area.
